(19) United States
(12) Patent Application Publication
(10) Pub. No.: US 2024/0127369 A1
(43) Pub. Date: Apr. 18, 2024

(54) Method and Device for Generating Charging Price Signals for an Electric Charging Site

(71) Applicant: ABB Schweiz AG, Baden (CH)

(72) Inventors: Zhenyuan Wang, Apex, NC (US); Alexander Brissette, Raleigh, NC (US); Yuzhi Zhang, Apex, NC (US); David Lee Coats, Apex, NC (US); Himani Ravindra Pathak, Bensalem, PA (US)

(73) Assignee: ABB Schweiz AG, Baden (CH)

(21) Appl. No.: 17/965,208

(22) Filed: Oct. 13, 2022

(51) Int. Cl. G06Q 50/06; G06Q 30/02

(52) U.S. Cl. CPC G06Q 50/06; G06Q 30/0204; G06Q 30/0206; B60L 53/60

(57) ABSTRACT

A method for determining a charging price for an electric charging site includes receiving time tags and data obtained based on automated metering infrastructure (AMI) data for the electric charging site, and weather information for a service area of the electric charging site; clustering power consumption of the electric charging site with similar weather information and time tags; calculating a center of mass and a distribution confidence parameter for the clustered power consumption to obtain a look-up table; retrieving historical information of voltage V_{PCC} and injection power Pₛᵢₜₑ pairs that is measured at a point of common coupling (PCC) of the electric charging site; receiving weather forecast information for the service area of the electric charging site; and calculating a dynamic hosting capacity (DHC) curve and a price curve based on the center of mass and the distribution confidence parameter, the V_{PCC} and Pₛᵢₜₑ pairs, and the weather forecast information.

### FIELD

Generally, the present disclosure relates to charging loads on a power system operation for electric vehicles (EVs) and, more specifically, to a method and device for generation of charging price signals for electric charging sites.

### BACKGROUND

With the fast adoption of electric vehicles (EVs) in our society, utilities have growing concerns over the impact of charging loads on power system operations. Utilities themselves are also increasingly operating as EV charging point operators at small or larger scales. There is a growing need to incentivize EV charging point operators (CPO) or operation algorithms/agents to control their charging loads intelligently to avoid adverse impacts of these loads on power system operations. One of the many approaches is to use a charging price signal to make EV charging point operators aware of any pending power system stresses, so the EV charging point operators can take appropriate actions to control charging loads during stressful system operations. This process is called price responsive load management. However, some traditional approaches are complex and costly to implement. Some approaches under development are too challenging to put into practice any time soon.

Therefore, there is a need to have an alternative approach to generate the price signals sensibly to allow CPOs to manage charging loads at their electric charging stations.

### SUMMARY

Exemplary embodiments of the present disclosure provide a method for a device to determine a charging price for an electric charging site. The device includes one or more processors configured to perform the method. The method includes:

An off-line process to generate the weather and time dependent load profiles of a power delivery distribution feeder (the feeder), and an on-line process to derive the real-time price signal representing the risk of voltage violations for the charging site.

The method further includes data analytical considerations to use utility automated metering infrastructure (AMI) data to derive feeder load profiles, and a digital simulation model (digital twin) of the feeder to derive the feeder load, charging site voltage, load, dynamic hosting capacity and the price signal curve.

In another exemplary embodiment, the present disclosure provides a method for a device to determine a charging price for an electric charging site. The device includes one or more processors configured to perform the method. The method includes receiving time tags and data for at least one electric charging site, which are obtained based on automated metering infrastructure (AMI) data for the at least one electric charging site, and temperature and/or weather related information for a service area of the at least one electric charging site; clustering power consumption of the at least one electric charging site with similar temperature and/or weather related information and time tags; calculating a center of mass and a distribution confidence parameter for the clustered power consumption of the at least one electric charging site to obtain a look-up table; retrieving historical information of voltage V_{PCC} and injection power Pₛᵢₜₑ pairs that is measured at a point of common coupling (PCC) of the at least one electric charging site and stored on a memory of the device; receiving weather forecast information for the service area of the at least one electric charging site; and calculating a dynamic hosting capacity (DHC) curve and a price curve for the at least one electric charging site based on the center of mass and the distribution confidence parameter for the clustered power consumption, the historical information of voltage V_{PCC} and injection power Pₛᵢₜₑ pairs, and the weather forecast information.

The first three method steps are off-line and the last three method steps are on-line.

The method further includes identifying a maximum DHC line and a minimum DHC line of the DHC-time plane; identifying an upper premium price boundary (UPPB) and a lower premium price boundary (LPPB) of the DHC-time plane; and dividing a region between the maximum DHC line and the minimum DHC line of the DHC-time plane into three sub-regions. The three sub-regions include a first premium price region that is between the maximum DHC line and the UPPB of the DHC-time plane, a second premium price region that is between the LPPB and the minimum DHC line of the DHC-time plane, and a DHC based price region that is between the UPPB and LPPB of the DHC-time plane.

The method further includes dividing the DHC based price region into a region for load and a region for price p generation according to the following equations:

p=p_{nr_scr},Pₛᵢₜₑ∈[0,DHC_{uppb-P}_{_{ffl}}]

p=p_{nr_scr}−p_{nr_scr}^{max}[(Pₛᵢₜₑ−DHC_{uppb-P}_{_{ffl}})/(DHC_{max-P}_{_{ffl}}−DHC_{uppb-P}_{_{ffl}})]²,Pₛᵢₜₑ>DHC_{uppb-P}_{_{ffl}}

p=p_{nr_ld},Pₛᵢₜₑε[DHC_{lppb-P}_{_{ffl}},0]

p=p_{nr_ld}+p_{nr_ld}^{max}[(Pₛᵢₜₑ−DHC_{uppb-P}_{_{ffl}})/(DHC_{min-P}_{_{ffl}}−DHC_{uppb-P}_{_{ffl}})]²,Pₛᵢₜₑ<DHC_{lppb-P}_{_{ffl}}

where p_{nr_scr} represents a normal compensation price for distributed energy resource (DER) injection power Pₛᵢₜₑ (positive) into a grid from the PCC of the electric charging site; p_{nr_ld} represents a normal billing price for electric charging site load power Pₛᵢₜₑ (negative) drawn from the grid at the PCC of the electric charging site. p_{nr_scr}^{max} and p_{nr_ld}^{max} represent maximum penalty prices the electric charging site needs to pay at its power injection or sink operation modes relative to the grid, respectively.

The identifying the maximum DHC line and the minimum DHC line of the DHC-time plane includes deriving per unit voltage deviations δV from a nominal value based on the historical information of voltage V_{PCC} and injection power Pₛᵢₜₑ pairs according to the following equation:

δV=V_{PCC}/V_{Base}−1

where V_{Base} is a rated voltage at the PCC of the electric charging site, plotting the derived points of the per unit voltage deviations δV and the injection power Pₛᵢₜₑ on a corresponding graph to obtain a δV-Pₛᵢₜₑ curve; and deriving the maximum DHC line and the minimum DHC line of the DHC-time plane by extrapolating the δV-Pₛᵢₜₑ curve to intercept with a δVₘₐₓ threshold and a δVₘᵢₙ threshold based on a curve fitting method or a machine learning process.

The δVₘₐₓ threshold and the δVₘᵢₙ threshold are 0.05 and −0.05, respectively, according to local regulatory voltage limits.

The identifying the UPPB and the LPPB of the DHC-time plane includes determining two corresponding voltage deviation thresholds δV_{uppb} and δV_{lppb}, respectively, based on the δV-Pₛᵢₜₑ curve; and determining the UPPB and the LPPB of the DHC-time plane by the two corresponding voltage deviation thresholds δV_{uppb} and δV_{lppb}. The two corresponding voltage deviation thresholds δV_{uppb} and δV_{lppb} are configuration parameters determined by how sensitive the voltage V_{PCC} is to an injection power Pₛᵢₜₑ change.

The two corresponding voltage derivation thresholds δV_{uppb} and δV_{lppb} are at least one of: chosen arbitrarily; according to voltage sensitivity study of the at least one electric charging site; or 0.04 and −0.04, respectively, when statutory limits for the δVₘₐₓ threshold and the δVₘᵢₙ threshold are 0.05 and −0.05, respectively.

The method further includes updating the look-up table with the information of weather forecast for the service area of the at least one electric charging site, the DHC curve and the price curve for the at least one electric charging site.

The method further includes training the device with the updated look-up table for calculating DHC curves and price curves for electric charging sites.

In another exemplary embodiment, the present disclosure provides a device for determining multiple price regions based on the dynamic hosting capacity concept, where the boundary of the regions is determined by curve fitting method.

The device further includes algorithm to calculate charging site price from dynamic hosting capacity based on a set of linear or quadratic equations.

In another exemplary embodiment, the present disclosure provides a device for determining a charging price for an electric charging site, the device including one or more processors configured to receive time tags and data for at least one electric charging site, which are obtained based on automated metering infrastructure (AMI) data for the at least one electric charging site, and temperature and/or weather related information for a service area of the at least one electric charging site; cluster power consumption of the at least one electric charging site with similar temperature and/or weather related information and time tags; calculate a center of mass and a distribution confidence parameter for the clustered power consumption of the at least one electric charging site to obtain a look-up table; retrieve historical information of voltage V_{PCC} and injection power Pₛᵢₜₑ pairs that is measured at a point of common coupling (PCC) of the at least one electric charging site and stored on a memory of the device; receive weather forecast information for the service area of the at least one electric charging site; and calculate a dynamic hosting capacity (DHC) curve and a price curve for the at least one electric charging site based on the center of mass and the distribution confidence parameter for the clustered power consumption, the historical information of voltage V_{PCC} and injection power Pₛᵢₜₑ pairs, and the weather forecast information.

In another exemplary embodiment, the present disclosure provides a non-transitory computer-readable medium having computer-executable instructions stored thereon which, when executed by one or more processors, cause a device to receive time tags and data for at least one electric charging site, which are obtained based on automated metering infrastructure (AMI) data for the at least one electric charging site, and temperature and/or weather related information for a service area of the at least one electric charging site; cluster power consumption of the at least one electric charging site with similar temperature and/or weather related information and time tags; calculate a center of mass and a distribution confidence parameter for the clustered power consumption of the at least one electric charging site to obtain a look-up table; retrieve historical information of voltage V_{PCC} and injection power Pₛᵢₜₑ pairs that is measured at a point of common coupling (PCC) of the at least one electric charging site and stored on a memory of the device; receive weather forecast information for the service area of the at least one electric charging site; and calculate a dynamic hosting capacity (DHC) curve and a price curve for the at least one electric charging site based on the center of mass and the distribution confidence parameter for the clustered power consumption, the historical information of voltage V_{PCC} and injection power Pₛᵢₜₑ pairs, and the weather forecast information.

### BRIEF DESCRIPTION OF THE DRAWING(S)

FIG. 1 is a schematic diagram of an electric charging site connecting to a power delivery distribution feeder for charging electric vehicles (EVs) according to an exemplary embodiment of the present disclosure;

FIG. 2 is a schematic flowchart for generating a charging price signal to present to EV drivers for an electric charging site according to an exemplary embodiment of the present disclosure;

FIG. 3 is a schematic diagram of dynamic hosting capacity (DHC) based price regions for generating a charging price signal to present to EV drivers for an electric charging site according to an exemplary embodiment of the present disclosure;

FIG. 4 is a schematic diagram of a relationship of per unit voltage deviations and an electric charging site's loading on a corresponding graph according to an exemplary embodiment of the present disclosure;

FIG. 5 is a schematic diagram of a relationship of per unit voltage deviations and an electric charging site's loading based on a deduction of four dynamic hosting capacities (DHCs) on a corresponding graph according to an exemplary embodiment of the present disclosure;

FIG. 6 is a schematic diagram of an electric charging site price model based on dynamic hosting capacity (DHC) according to an exemplary embodiment of the present disclosure;

FIG. 7 is a schematic flowchart of a method for a device to determine a charging price for an electric charging site to present to an EV driver for the electric charging site according to an exemplary embodiment of the present disclosure;

FIG. 8 is a schematic flowchart of a method for a device to determine a charging price for an electric charging site to present to an EV driver for the electric charging site according to an exemplary embodiment of the present disclosure;

FIG. 9 is a schematic flowchart of a method for a device to determine a charging price for an electric charging site to present to an EV driver for the electric charging site according to an exemplary embodiment of the present disclosure;

FIG. 10 is a schematic flowchart of a method for a device to determine a charging price for an electric charging site to present to an EV driver for the electric charging site according to an exemplary embodiment of the present disclosure;

FIG. 11 is a schematic flowchart of a method for a device to determine a charging price for an electric charging site to present to an EV driver for the electric charging site according to an exemplary embodiment of the present disclosure;

FIG. 12 is a schematic flowchart of a method for a device to determine a charging price for an electric charging site to present to an EV driver for the electric charging site according to an exemplary embodiment of the present disclosure; and

FIG. 13 is a schematic diagram of a device for determining a charging price for an electric charging site so to generate a charging price signal to present to an EV driver at the electric charging site according to an exemplary embodiment of the present disclosure.

### DETAILED DESCRIPTION

Exemplary embodiments of the present disclosure provide a method for determining a representative energy delivery price (charging price) for an electric charging site using an electric vehicle supply equipment (EVSE) device, the charger. The method includes: (1) receiving load profile and time tags dataset for at least one electric charging site, which are obtained based on automated metering infrastructure (AMI) data for the at least one electric charging site, and weather data (e.g., an ambient temperature) for a service area of the at least one electric charging site; (2) clustering power consumption of the at least one electric charging site with similar ambient temperature and time tags; (3) calculating a center of mass and a distribution confidence parameter for the clustered power consumption of the at least one electric charging site to obtain a look-up table; (4) retrieving historical information of voltage V_{PCC} and injection power Pₛᵢₜₑ pairs that is measured at a point of common coupling (PCC) of the at least one electric charging site and stored on a memory of the device; (5) receiving weather forecast information for the service area of the at least one electric charging site; and (6) calculating a dynamic hosting capacity (DHC) curve and a price curve for the at least one electric charging site based on the center of mass and the distribution confidence parameter for the clustered power consumption, the historical information of voltage V_{PCC} and injection power Pₛᵢₜₑ pairs, and the weather forecast information.

With the growing use of electric vehicles (EVs), electric charging sites for charging EVs have grown rapidly. EV charging point operators or operation algorithms/agents for electric charging sites wish to control charging loads of their electric charging sites intelligently to avoid adverse impacts of these loads on power system operations, and/or to reduce their risk of paying heavy electricity peak demand charges to the utility serving them. In general, dynamic hosting capacity (DHC) parameters at an electric charging site's point of common coupling (PCC) is derived for subject time. These DHC parameters are used in turn to derive a charging price as a function of PCC power, namely, Pₛᵢₜₑ, to discourage charging demands by EV drivers that could cause voltage violations at the PCC. For example, the charging price may be represented by f (PCC power) or f (Pₛᵢₜₑ). That is, various PCC power results in different charging prices for an electric charging site.

One approach is to use a charging price signal to make EV charging point operators or operation algorithms/agents for electric charging sites aware of possible pending power system stresses. With that awareness, the EV charging point operators or operation algorithms/agents can take appropriate actions to control the charging loads of their electric charging sites, and thus, avoiding potential voltage violations at PCCs of their electric charging sites. This process is called a price responsive load management.

A traditional way of generating a charging price signal for a power system is to use the optimal power flow (OPF) based locational marginal price (LMP) calculation method. This method requires a detailed electrical system model for the feeder and adjacent territories of the utility service area, detailed information about load demands, e.g., charging demands from EVs, and generator model of EVs, and fuel costs at an electric charging site. For those electric charging stations that are connected to an electric power distribution network, this approach is too complex and costly to implement.

In addition, the LMP based price generation method typically only applies in a deregulated energy market for a wholesale market, which is traditionally oriented for transmission systems. In such a wholesale market, network models and methodologies are usually mature and validated. On the other hand, the energy market in distribution systems is still in its infancy. There are many more stakeholders to be satisfied. Further, the energy market in distribution systems is expected to take a longer time to develop. Therefore, it remains challenging to put an OPF based distribution LMP calculation method into practice.

As such, an alternative method, which can preferably leverage data analytics, is highly desirable. This alternative method may be also described as a data-based solution. According to exemplary embodiments of the present disclosure, the methods and devices provided herein do not need an enterprise level OPF based algorithm to determine a charging price at an electric charging site. Thus, they can be implemented easily for each electric charging site using the disclosed process and implemented architecture. Further, a curve fitting method to determine DHC parameters in real time is introduced. Furthermore, the methods and devices provided herein introduce a premium price scheme to discourage load demands/charging demands at an electric charging site that can cause network constraint violations, for example, an overvoltage situation or an under-voltage situation.

In general, the methods and devices provided herein enable charging site operators to inform the consumers of a charging price at an electric charging site. For example, a message may be, the consumers have to pay more to charge their EVs at certain point in time due to the current strained state of the grid. For instance, charging high prices is to discourage the consumers from charging their EVs, and thus, to relive the strain on the grid. The methods and devices may be also applied to other types of load managements. For example, charging high prices at a café of an electric charging site is to discourage running heating, ventilation, and air conditioning (HVAC) in the café.

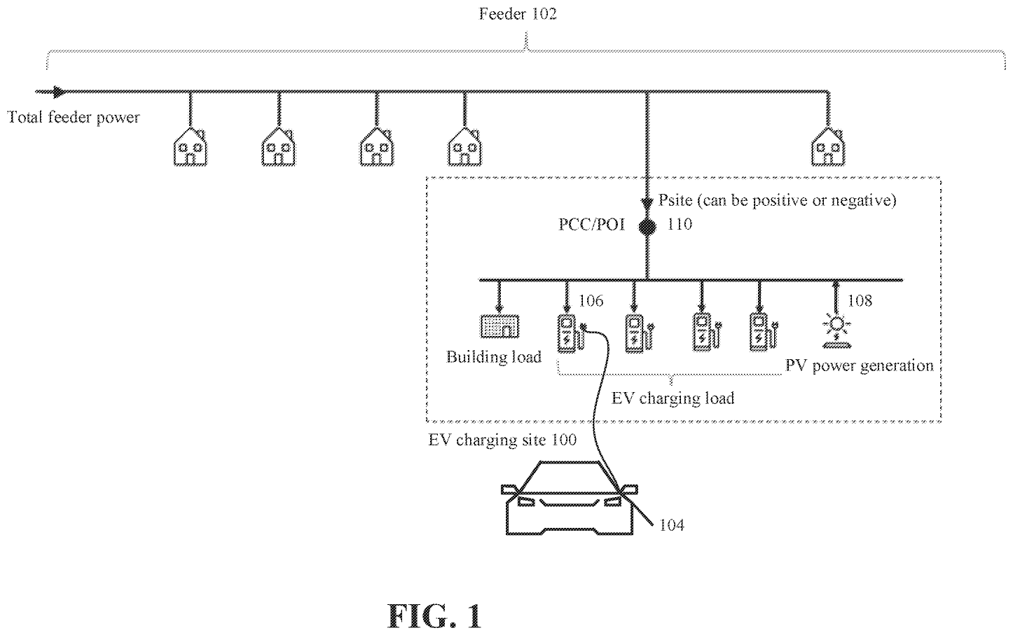

FIG. 1 is a schematic diagram of an electric charging site connecting to a power delivery distribution feeder for charging electric vehicles (EVs). The electric charging site 100 may be located in residential places and commercial places, which are also connected to the power delivery distribution feeder 102. The electric charging site 100 may include a distributed energy resource (DER), such as a solar or wind based DER. As shown in FIG. 1, at least one power delivery distribution feeder 102 supplies residential houses/commercial buildings, it also supplies an electric charging site 100 via point of common coupling (PCC) or point of interaction (POI) 110 of the electric charging site 100.

The feeder 102 acts as a central circuit that controls and distributes electricity to outgoing circuits downstream, for example, serving neighborhood or even a town through power lines. Through the power lines, the feeder 102 distributes electricity to the electric charging site 100, which in turn distributes electricity to EVs 104 as shown in FIG. 1 through a charger or electric vehicle supply equipment (EVSE) 106 of the electric charging site 100. The electricity is stored on a battery in the EV for propulsion of the one or more motors of the EV. By government regulations, utilities need to maintain the feeder 102's voltage at any load connection points (e.g., PCC/POI of site 100), which may go up or down when the feeder 102 hosts large EV charging loads and/or generation resources.

As shown in FIG. 1, the electric charging site 100 also includes a distributed energy resource (DER), for example, a solar photovoltaic (PV) power generation 108. With the PV power generation 108, the electric charging site 100 is able to generate power other than demand it, for example, load/charging demands by EVs. In some exemplary applications, the electric charging site 100 may send the power generated by the PV power generation 108 back to the grid, for example, when total building load and EV load/charging demands are low and the solar output is high.

Generally, voltage rise by the DER should be kept under a maximum permissible voltage rise, which is defined as the voltage rise that brings the maximum voltage magnitude exactly to the regulatory overvoltage limit. A hosting capacity is used to indicate a maximum amount of generation by the DER. For example, within the maximum amount of generation, there should be no compromising of power quality indexes, and at the same time, an assurance of the system reliability. Therefore, dynamic behaviors of the hosting capacity, namely the hosting capacity in relation to an integrated impact of harmonic voltage distortion and voltage rise, throughout a period of time is observed and analyzed. The period of time may include, for example, daily, weekly, monthly, or even yearly periods. The dynamic behaviors of the hosting capacity is known as dynamic hosting capacity (DHC). Conversely, voltage dip cannot be lower than a permissible value (typically 0.95 per unit), and the site 100's net load should be limited to not cause the voltage dip violation. We can consider the net load requirement as negative dynamic hosting capacity (DHC) for site 100.

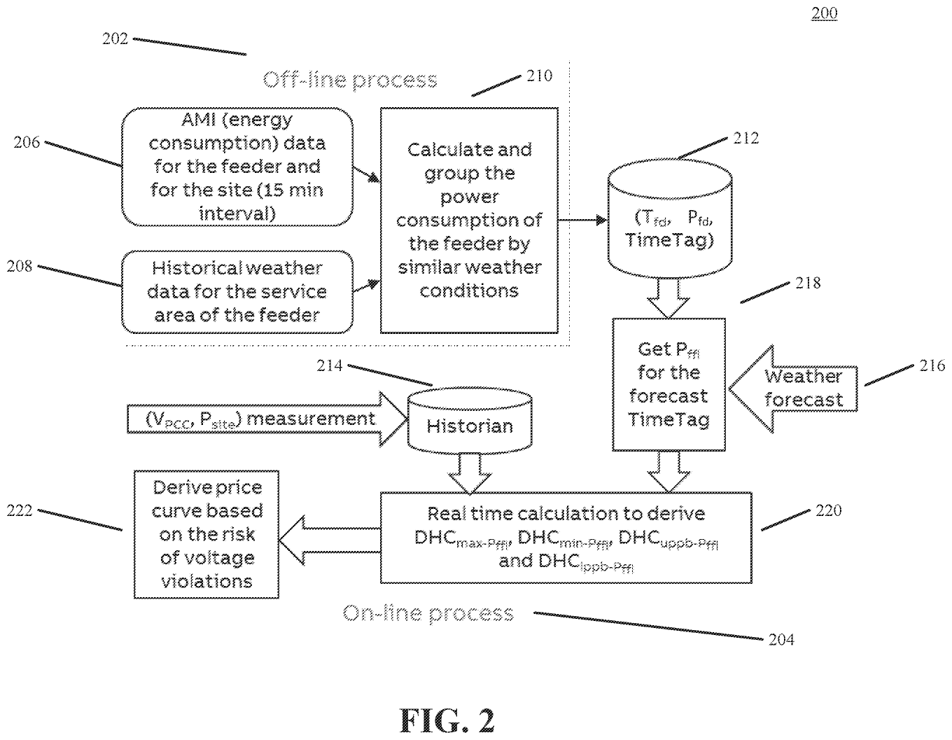

FIG. 2 is a schematic flowchart for generating a charging price signal to present to EV drivers at an electric charging site. As shown in FIG. 2, the process 200 generates charging price signals for a particular DER integration or load connection point, for example, an electric charging site 100 as shown in FIG. 1. The electric charging site may have installed chargers, renewable generation, battery energy storage system, and other varied loads/resources. The charging price signals are generated for a particular power delivery distribution feeder's load connection point, for example, charging site 100 of a feeder 102 as shown in FIG. 1, based on mainly the forecasted feeder load P_{ffl}. Feeder load is the net power drawn/generated by all the resources on the feeder. For example, as shown in FIG. 1, the feeder 102 serves houses, the electric charging site 100 with multiple chargers 106 and a PV power generation 108. The forecasted feeder load P_{ffl} is the instantaneous load at a certain point of time in the future.

Therefore, the generation of the charging price signals takes into account feeder's loading conditions over time, namely feeder load profiles. Furthermore, the charging price signals is a function of the voltage V_{PCC} and net power injection Pₛᵢₜₑ, f (Pₛᵢₜₑ), from the electric charging site's point of common coupling (PCC) or point of interaction (POI). As shown in FIG. 1, the connecting point 110 connects the electric charging site 100 and the feeder 102, namely the utility system, is known as PCC or POI. Pₛᵢₜₑ is defined as the power that goes through the connecting point 110. The loads, e.g., load/charging demands by EVs, and the generations, e.g., the PV power generation 108, share the same PCC or POI, and thus, Pₛᵢₜₑ is the net power of all loads and generation.

The process 200 for generating charging price signals for an electric charging site includes an off-line process 202 and an on-line process 204, as shown in FIG. 2. Additionally and/or alternatively, the off-line process 202 may be also executed as an on-line process. For example, the off-line process 202 may run together with the on-line process 204 almost simultaneously to provide necessary inputs to start the on-line process 204. Under that circumstance, the off-line process 202 and the on-line process 204 may be carried out by a controller of the electric charging site and/or a system model. Additionally, and/or alternatively, the off-line process 202 may also run in a remote cloud.

In the off-line process 202 as shown in FIG. 2, information such as data for at least one electric charging site and time tags will be retrieved. The data input for the off-line process 202 may include voltage and power measurements for the entire feeder, and weather data of the feeder as well. As shown at step 206 of FIG. 2, information such as data for the feeder and data for the electric charging site, is readily available from utility's automated metering infrastructure (AMI). For example, the utility's AMI typically makes a record at 15-minute time. For example, the time tag information includes time tags that are the 4×24 time points of a day categorized by day types, which may include workdays, holidays, and/or weekends.

Further, information such as ambient temperature for a service area of the at least one electric charging site will be also retrieved. As shown at step 208 of FIG. 2, the historical weather forecast information is generally weather data about the service area of the electric charging site. The historical weather forecast information is also generally readily available. For example, the historical weather forecast information may be obtained through the local weather service center. For example, the historical weather forecast information may be recorded individually by a user, or by the electric charging site.

In general, the off-line process 202 uses a large amount of data to build a prediction model based on historical data. Due to the volume of the data, this off-line process 202 may be time-consuming. However, once the prediction model is established, it can be used to make predictions based on current and future data, e.g., weather forecast, very quickly and with low computational power. For example, this prediction model may be used in a price generation algorithm.

According to an exemplary embodiment of the present disclosure, at step 210 of FIG. 2, data analytics using data analytics methods include clustering all power points of the electric charging site, i.e., all power consumption of the feeder, within the same “Weather/TimeTag” grid. Then, the data analytics using data analytics methods further include calculating a center of mass and a distribution confidence parameter for the clustered power consumption of the electric charging site. The center of mass represents an average value of the clustered power consumption of the electric charging site, for example, the feeder 102 as shown in FIG. 1. The distribution confidence parameter represents certain possibilities that the forecasted feeder load P_{ffl} has certain values. For example, the distribution confidence parameter may provide information such as “there is a 90% chance P_{ffl} could have the first value, there is a 75% chance P_{ffl} could have the second value, there is a 25% chance P_{ffl} could have the third value, etc.”

As such, the look-up table 212 is derived using data analytics methods based on the information of related data and ambient temperature of the at least one electric charging site, and based on the information of time tags as well. The look-up table 212 contains information such as T_{fd}, P_{fd} and TimeTag. T_{fd} represents outdoor temperature for the area, e.g., the neighborhood, where the feeder is located, for example, the feeder 102 of the electric charging site 100 as shown in FIG. 1. P_{fd} represents the total feeder load for the given T_{fd} and TimeTag. TimeTag represents related time information for which prediction can be made, for example one of the 4×24 time slots. T_{fd} may be ambient temperature of the neighborhood only, or the feeder only, additionally and/or alternatively, T_{fd} may include additional information of humidity and other parameters when necessary. Additionally and/or alternatively, the look-up table 212 may also include other types of information.

As shown in FIG. 2, the look-up table will be used to calculate the forecasted feeder load P_{ffl} during the on-line process 204. As discussed above, P_{ffl} represents the total feeder load power forecasted at some desired point of time in the future, as long as the TimeTag and the forecasted weather condition for the site are known.

The on-line process 204, as shown in FIG. 2, may be carried out by a controller of the electric charging site. Additionally and/or alternatively, the on-line process 204 may be carried out by the controller of the electric charging site based around a cloud application, which provides greater visibility and a real time measurement. The on-line process 204 may be carried out by a system model based digital twin, i.e., a digital simulation model. For example, the digital twin provides representative behavior based on limited inputs. For example, the digital twin maintains a historical record of voltage V_{PCC} and injection power Pₛᵢₜₑ pair, (V_{PCC}, Pₛᵢₜₑ), which is measured at the PCC/POI of the electric charging site. The digital twin maintains a historical record of the weather data and calculated P_{ffl} that is provided as an input from the off-line process 202. These historical records may be also regarded as a historian 214 for the on-line process 204. For example, the historian 214 may be stored on a device and/or a controller for generating charging price signals for an electric charging site, on a memory of the electric charging site, or on a memory of a remote cloud.

The term “real time” refers to at least one of the time of occurrence of the associated events, the time of measurement and collection of predetermined data, the time to process the data, and the time of a system response to the events and the environment. In the embodiments described herein, these activities and events occur substantially instantaneously.

If, for example, the historian 214 contains site PCC voltage and net load over a period of a year, the historian 214 may be regarded as having enough representation of site 100's operation conditions.

According to an exemplary embodiment of the present disclosure, real time weather forecast information 216 is provided to the on-line process 204. The real time weather forecast information 216 is up-to-date weather forecast information when running the on-line process 204, compared to the historical weather data for the service area of the at least one electric charging site at 208. The real time weather forecast information 216 may include ambient temperature of the service area of the electric charging site. Additionally and/or alternatively, the real time weather forecast information 216 may include additional information of humidity and other parameters of that service area when necessary.

During the on-line process 204, the look-up table 212 derived through the off-line process 202 is used to derive P_{ffl}, as shown at 218 in FIG. 2. Then, the derived Pi, the real time weather forecast information 216, and the historical (V_{PCC}, Pₛᵢₜₑ) measurements stored in the historian 214 are used to calculate a series of dynamic hosting capacity, as shown at 220 in FIG. 2. Then, a price curve, p (Pₛᵢₜₑ), is derived based on risks of voltage violations, as shown at 222 in FIG. 2. For example, the series of DHC is calculated first, and then, the price curve, p (Pₛᵢₜₑ), is calculated based on the series of DHC. For example, the series of DHC and the price curve p (Pₛᵢₜₑ) may be calculated and derived almost simultaneously.

According to an exemplary embodiment of the present disclosure, the above-described parameters generated through the on-line process 204 are used to update the off-line process 202. Further, the above-described parameters generated through the on-line process 204 are also used to further train the on-line process 204 itself. For example, the on-line process 204 may be trained based on the above-described parameters according to a machine-learning algorithm. Additionally and/or alternatively, other training methods may be also used for training the on-line process 204 based on the above-described parameters.

According to an exemplary embodiment of the present disclosure, a calculated DHC during the on-line process 204 represents the maximum permissible amount of generation or loading of an electric charging site, for example, the electric charging site 100 as shown in FIG. 1. In general, the DHC is bound by a maximum hosting capacity line and a minimum hosting capacity line. That is, the region between the maximum hosting capacity line and the minimum hosting capacity line shows a permissible amount of generation/loading of the electric charging site.

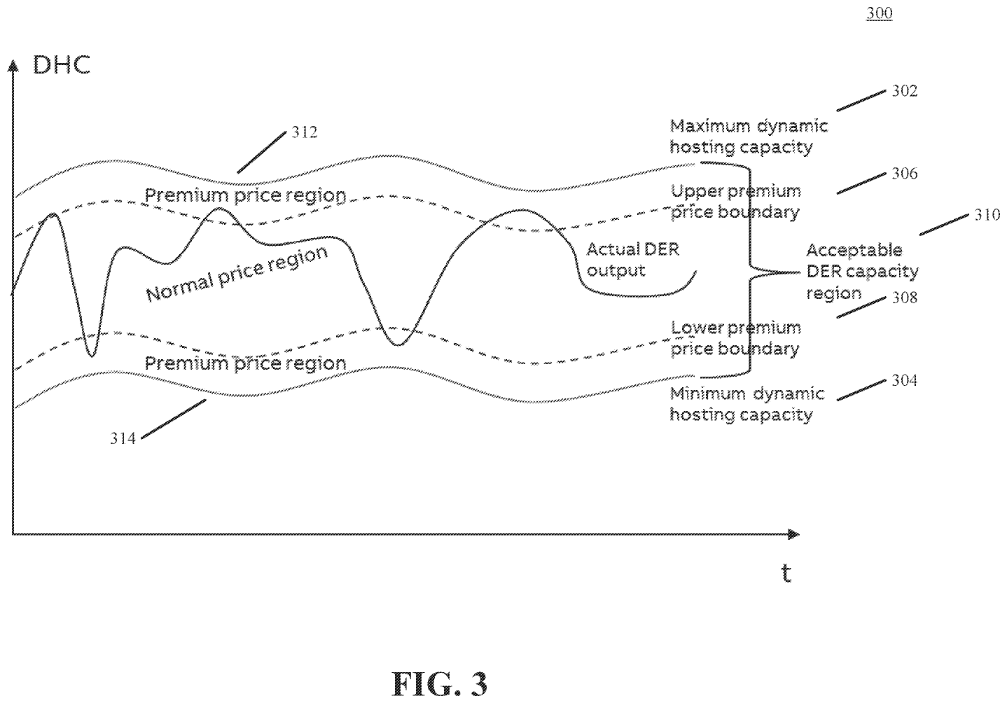

FIG. 3 is a schematic diagram of dynamic hosting capacity (DHC) based price regions for generating a charging price signal to present to EV drivers at an electric charging site. As shown in FIG. 3, a relationship between the hosting capacity and a specific period of time is shown in a graph 300, that is, a dynamic hosting capacity (DHC, also shown as (DHC (t)) (the DHC-time plane) is shown in the graph 300. As shown, a maximum dynamic hosting capacity line is identified as 302 on the graph 300 and a minimum dynamic hosting capacity line is identified as 304 on the graph 300.

According to an exemplary embodiment of the present disclosure, the region between the maximum dynamic hosting capacity line 302 and the minimum dynamic hosting capacity line 304 is further divided into three regions. These three regions include two premium price regions and a normal price region. For example, as shown in FIG. 3, the graph 300 further includes an upper premium price boundary (UPPB) 306 and a lower premium price boundary (LPPB) 308. With these two boundaries, a normal price region 310 is identified between the UPPB 306 and the LPPB 308. Further, a region between the maximum dynamic hosting capacity line 302 and the UPPB 306 is identified as a premium price region 312, for example, an upper premium price region 312. A region between the LPPB 308 and the minimum dynamic hosting capacity line 304 is identified as another premium price region 314, for example, a lower premium price region 314.

The definition of these two premium price regions 312 and 314 allows a penalty to be applied to a DER's charging price, namely, a charging price of the electric charging site 100 as shown in FIG. 1. For example, a penalty may be applied, when an output or a demand of the electric charging site is either close to the maximum DHC line 302 or close to the minimum DHC line 304.

As described above, based on P_{ffl} derived from the look-up table 212 through the off-line process 202 and the historical (V_{PCC}, PRO measurements stored in the historian 214 for the on-line process 204, as shown in FIG. 2, a per unit (p.u.) voltage deviations from the nominal value can be derived for a particular forecasted feeder load P_{ffl}. For example, a per unit (p.u.) voltage deviations from the nominal value may be derived for a particular forecasted feeder load P_{ffl} according to the following equation:

δV=V_{PCC}/V_{Base}−1 Equation 1

where V_{Base} is a rated voltage at the PCC of the electric charging site.

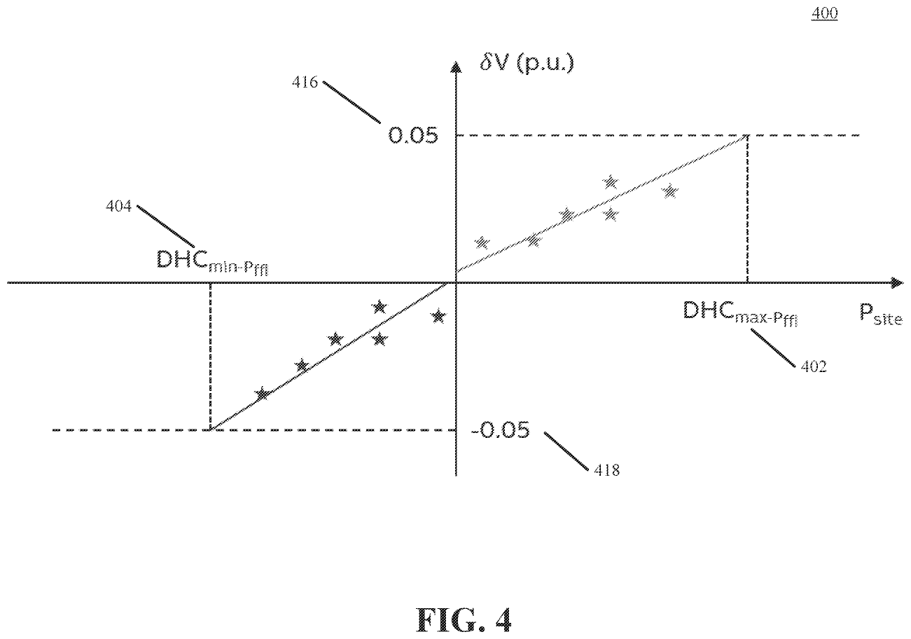

FIG. 4 is a schematic diagram of a relationship of per unit voltage deviations and an electric charging site's injection power on a corresponding graph. As shown in FIG. 4, on a δV-Pₛᵢₜₑ graph 400, the resulted (δV, Pₛᵢₜₑ) points can be plotted. By using a curve fitting method or a machine learning process or other types of method, the maximum DHC 402 and minimum DHC 404, which are represented by DHC_{max-P}_{_{ffl}} and DHC_{min-P}_{_{ffl}}, respectively, can be derived by extrapolating the δV-Pₛᵢₜₑ curve on the graph 400. For example, the maximum DHC 402 and minimum DHC 404 are derived by extrapolating the δV-Pₛᵢₜₑ curve to intercept with a δVₘₐₓ threshold and a δVₘᵢₙ threshold. As shown in FIG. 4, a δVₘₐₓ threshold, which is represented by 416 in FIG. 4, has a value of 0.05. As shown in FIG. 4, and a δVₘᵢₙ threshold, which is represented by 418, has a value of −0.05. Additionally and/or alternatively, other values of δVₘₐₓ 416 and δVₘᵢₙ 418 thresholds may be also applied, respectively, to derive the maximum DHC 402 and minimum DHC 404.

According to an exemplary embodiment of the present disclosure, as a next step of the on-line process 204 as shown in FIG. 2, the UPPB 306 and the LPPB 308 on the DHC graph 300 as shown in FIG. 3 are then respectively determined. For example, the UPPB 306 and the LPPB 308 on the DHC graph 300 as shown in FIG. 3 may be respectively determined by another two corresponding voltage deviation thresholds.

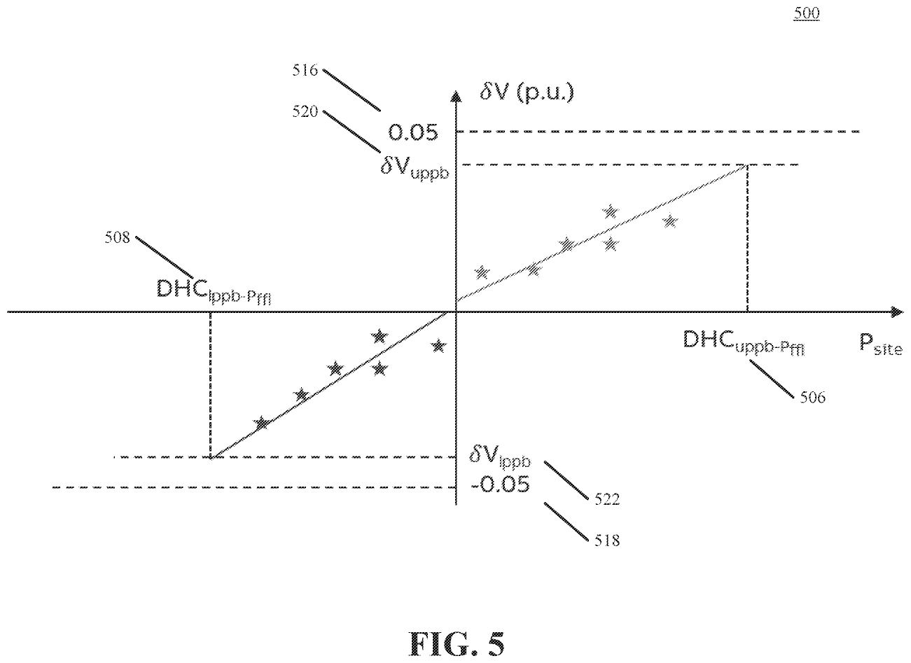

FIG. 5 is a schematic diagram of a relationship of per unit voltage deviations and an electric charging site's injection power based on a deduction of four dynamic hosting capacities (DHCs) on a corresponding graph. As shown in FIG. 5, on a δV-Pₛᵢₜₑ graph 500, another two corresponding voltage deviation thresholds are identified as 520 and 522, which are represented as δV_{uppb} and δV_{lppb} on the δV-Pₛᵢₜₑ graph 500, respectively. Further, the δVₘₐₓ and δVₘᵢₙ thresholds are now shown as 516 and 518 on the δV-Pₛᵢₜₑ graph 500 of FIG. 5. With these two corresponding voltage deviation thresholds 520 and 522, the UPPB 506 and the LPPB 508, which are represented as DHC_{uppb-P}_{_{ffl}} and DHC_{lppb-P}_{_{ffl}} on the δV-Pₛᵢₜₑ graph 500 of FIG. 5, respectively, can be determined. The determination of the UPPB 506 and the LPPB 508 is based on the same curve fitting for the determination of the maximum DHC 402 and minimum DHC 404 on the δV-Pₛᵢₜₑ graph 400, as shown in FIG. 4.

According to an exemplary embodiment of the present disclosure, the two corresponding voltage deviation thresholds 520 and 522 may be determined by how sensitive the voltage V_{PCC} of the PCC of the electric charging site 100 as shown in FIG. 1 is to an injection power Pₛᵢₜₑ change. In some applications, the two corresponding voltage deviation thresholds 520 and 522 may be defaulted to 0.04 and −0.04, respectively. Additionally and/or alternatively, other values for the two corresponding voltage deviation thresholds 520 and 522 may be also applied.

As such, four DHC values, which include the maximum DHC 402 and minimum DHC 404 as shown in FIG. 4, and the UPPB 506 and the LPPB 508 as shown in FIG. 5, are determined for the P_{ffl}. The on-line process 204 as shown in FIG. 2 further includes establishing a relationship between price (p) and net power injection Pₛᵢₜₑ from the electric charging site's PCC. For example, the price (p)−Pₛᵢₜₑ relationship, also known as a price responsive load model, can be derived according to a piecewise function with different sub-functions in each region of a dynamic hosting capacity range. These regions include the upper premium price region 312, the lower premium price region 314, and the normal price region 310, as shown in FIG. 3.

According to an exemplary embodiment of the present disclosure, the normal price region 310 of FIG. 3 may be further divided into a region for load and a region for generation. A region for load represents situations where site DER cannot supply site load and the site presents itself as a net load/demand. A region for generation represents situations where site DER output is sufficient to supply site load, and the site presents itself as a net generation source. For example, the region for load and the region for generation respectively correspond to different sub-functions as follows:

p=p_{nr_scr},Pₛᵢₜₑ∈[0,DHC_{uppb-P}_{_{ffl}}] Equation 2

p=p_{nr_scr}−p_{nr_scr}^{max}[(Pₛᵢₜₑ−DHC_{uppb-P}_{_{ffl}})/(DHC_{max-P}_{_{ffl}}−DHC_{uppb-P}_{_{ffl}})]²,Pₛᵢₜₑ>DHC_{uppb-P}_{_{ffl}} Equation 3

p=p_{nr_ld},Pₛᵢₜₑ∈[DHC_{lppb-P}_{_{ffl}},0] Equation 4

p=p_{nr_ld}+p_{nr_ld}^{max}[(Pₛᵢₜₑ−DHC_{uppb-P}_{_{ffl}})/(DHC_{min-P}_{_{ffl}}−DHC_{uppb-P}_{_{ffl}})]²,Pₛᵢₜₑ<DHC_{lppb-P}_{_{ffl}} Equation 5

where p_{nr_scr} represents a normal compensation price for distributed energy resource (DER) injection power Pₛᵢₜₑ (positive) into a grid from the PCC of the electric charging site 100, as shown in FIG. 1. Under this circumstance, the total power generation of the electric charging site, i.e., the DER output, exceeds the total loads, i.e., the charging/load demands by EVs. The local utility system may compensate the operator of the electric charging site for the generated power. However, the compensation rate may be different than the rate the operator is charged when the electric charging site absorbs power rather than inject power; where p_{nr_ld} represents a normal billing price for electric charging site load power Pₛᵢₜₑ (negative) drawn from the grid at the PCC of the electric charging site 100, as shown in FIG. 1;
where p_{nr_scr}^{max} and p_{nr_ld}^{max} represent maximum penalty prices the electric charging site 100 of FIG. 1 needs to pay at its power injection or sink operation modes relative to the grid, respectively.

According to an exemplary embodiment of the present disclosure, the electric charging site power Pₛᵢₜₑ may be controlled to be within the range of (DHC_{min-P}_{_{ffl}}, DHC_{max-P}_{_{ffl}}), shown as 404 and 402 on the δV-Pₛᵢₜₑ graph 400 of FIG. 4. Additionally and/or alternatively, the electric charging site power Pₛᵢₜₑ may be controlled within other ranges of the minimum DHC 404 and maximum DHC 402.

As such, an establishment of a relationship between price (p) and net power injection Pₛᵢₜₑ from the electric charging site's PCC can be made based on the calculated regions for load and for generation according to the piecewise function with different sub-functions as described above.

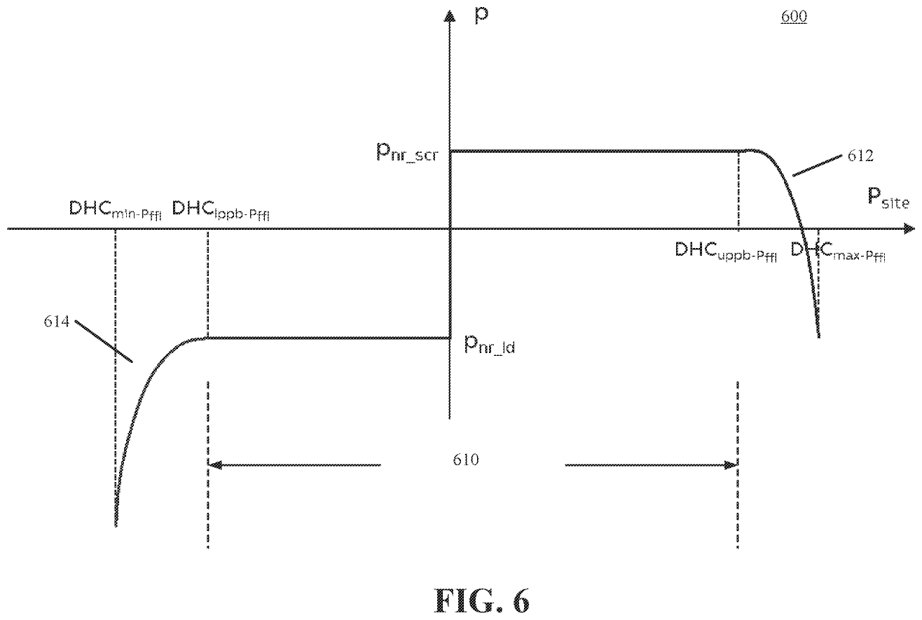

FIG. 6 is a schematic diagram of an electric charging site price model based on dynamic hosting capacity (DHC). As shown in FIG. 6, a pictorial representation 600 shows a relationship of price (p) and net power injection Pₛᵢₜₑ. According to an exemplary embodiment of the present disclosure, in this pictorial representation 600 of the price (p)−Pₛᵢₜₑ relationship, the upper premium price region 612 and the lower premium price region 614 are quadratic. That is, the functions for the upper premium price region 612 and the lower premium price region 614, according to Equation 3 and Equation 5, are quadratic. Further, in this pictorial representation 600 of the price (p)−Pₛᵢₜₑ relationship, the normal price region 610 is linear. That is, the functions for the normal price region 610, Equation 2 and Equation 4, are linear.

According to some other exemplary embodiments of the present disclosure, the functions for the upper premium price region 612 and the lower premium price region 614 may be linear rather than quadratic. That is, various other functions may be used. However, those functions generally require a price increase with increasing power in a premium region for a load situation, and further, requires a compensation reduction with increasing power in a premium region for a generation situation.

According to some other exemplary embodiments of the present disclosure, variations of the functions applied within a normal price region, for example, the normal price region 610 as shown in FIG. 6, are allowed. Further, variations of the functions applied within a premium price region, for example, the premium price regions 612 and 614 as shown in FIG. 6, are also allowed. The variations over the normal price region should be small relative to the variations over the premium price regions in order to appropriately discourage operation near these limits of the DHC.

According to some exemplary embodiments of the present disclosure, a variation of the off-line process 202 described according to FIG. 2 could also include a prediction method to provide binary or confidence interval ranges for likelihood of a charging price that will be accepted by a user within a given time interval. This set of behavioral likelihood metrics could then be provided as another model or digital twin input for feedback in determining a charging price for an electric charging site.

According to some exemplary embodiments of the present disclosure, user satisfaction ratings could be requested after charging users at the electric charging site to provide test criteria for additional training of the off-line process 202 and the on-line process 204, as shown in FIG. 2.

According to some exemplary embodiments of the present disclosure, electric charging site price signal receivers could provide hard or soft limits for key parameters to charging and management controllers at the electric charging site that set additional constraints. For example, a method to check validity of settings would be implemented to ensure solvable conditions.

According to some exemplary embodiments of the present disclosure, the methods introduced herein could be used to run a distribution energy market without the need for OPF or a full network model. For example, economic dispatch is performed to get the nodal generation/load and baseline system price, and then, charging prices are adjusted at each node as a function of the DHC limits.

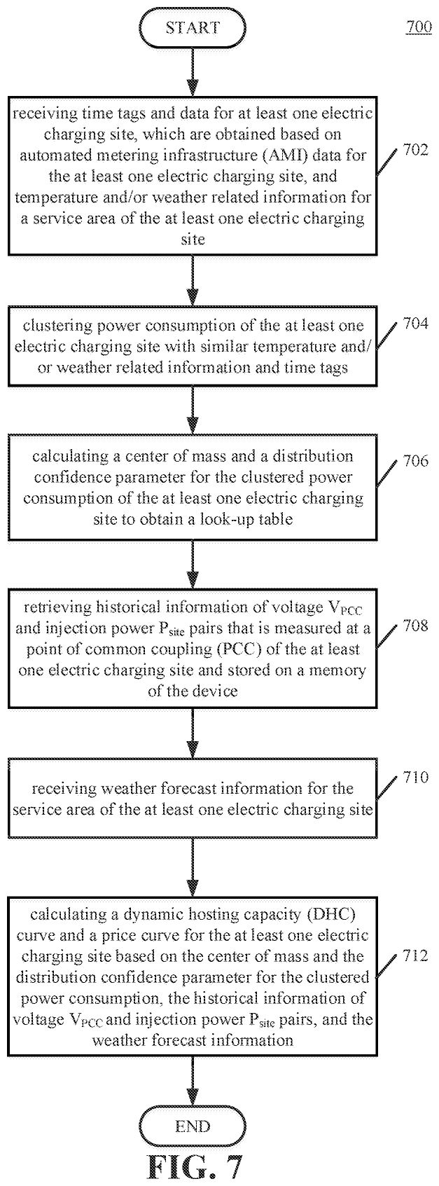

FIG. 7 is a schematic flowchart of a method 700 for determining a charging price for an electric charging site using a device so to generate a charging price signal to present to an EV driver at the electric charging site. As shown in FIG. 7, the method 700 for the device includes the following steps:

At step 702, the device receives time tags and data for at least one electric charging site, which are obtained based on automated metering infrastructure (AMI) data for the at least one electric charging site, and temperature and/or weather related information for a service area of the at least one electric charging site.

At step 704, the device clusters power consumption of the at least one electric charging site with similar temperature and/or weather related information and time tags.

At step 706, the device calculates a center of mass and a distribution confidence parameter for the clustered power consumption of the at least one electric charging site to obtain a look-up table.

At step 708, the device retrieves historical information of voltage V_{PCC} and injection power Pₛᵢₜₑ pairs that is measured at a point of common coupling (PCC) of the at least one electric charging site and stored on a memory of the device.

At step 710, the device receives weather forecast information for the service area of the at least one electric charging site.

At step 712, the device calculates a dynamic hosting capacity (DHC) curve and a price curve for the at least one electric charging site based on the center of mass and the distribution confidence parameter for the clustered power consumption, the historical information of voltage V_{PCC} and injection power Pₛᵢₜₑ pairs, and the weather forecast information.

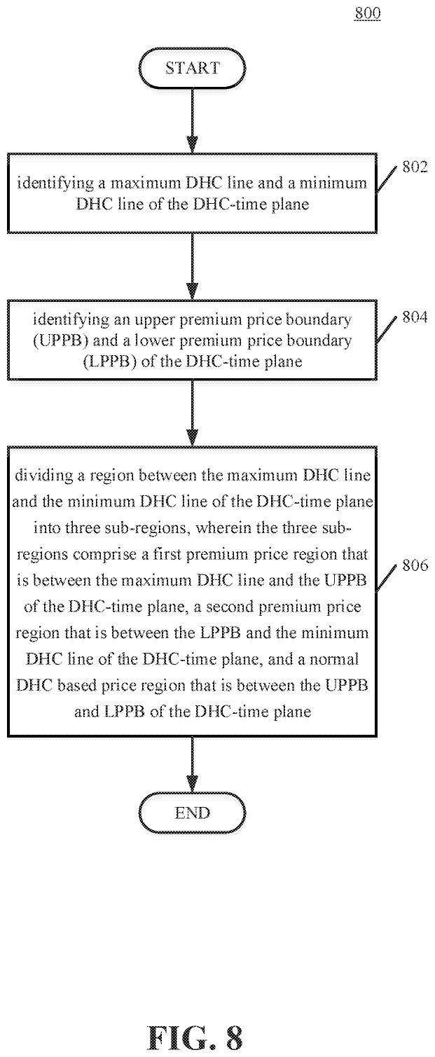

FIG. 8 is a schematic flowchart of a method 800 for determining a charging price for an electric charging site using a device so to generate a charging price signal to present to an EV driver at the electric charging site. As shown in FIG. 8, the method 800 for the device includes the following further steps:

At step 802, the device identifies a maximum DHC line and a minimum DHC line of the DHC-time plane.

At step 804, the device identifies an upper premium price boundary (UPPB) and a lower premium price boundary (LPPB) of the DHC-time plane.

At step 806, the device divides a region between the maximum DHC line and the minimum DHC line of the DHC-time plane into three sub-regions. The three sub-regions comprise a first premium price region that is between the maximum DHC line and the UPPB of the DHC-time plane, a second premium price region that is between the LPPB and the minimum DHC line of the DHC-time plane, and a DHC based price region that is between the UPPB and LPPB of the DHC-time plane.

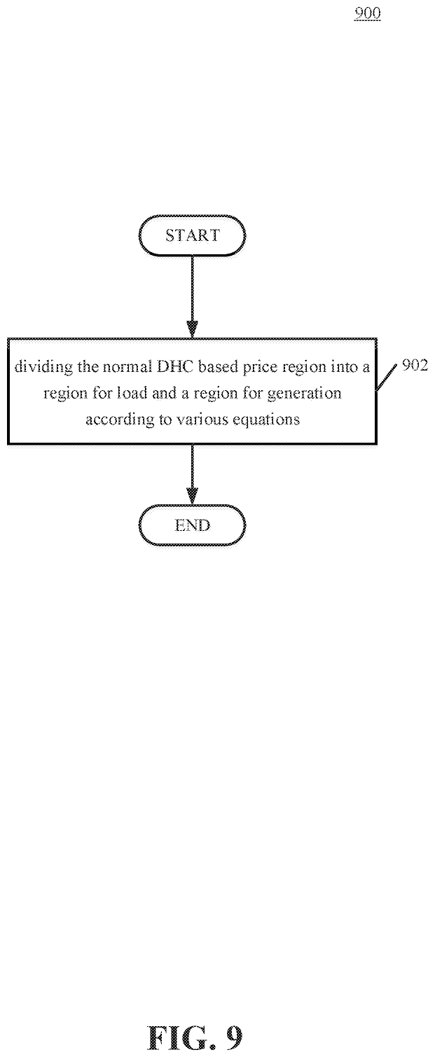

FIG. 9 is a schematic flowchart of a method 900 for determining a charging price for an electric charging site using a device so to generate a charging price signal to present to an EV driver at the electric charging site. As shown in FIG. 9, the method 900 for the device includes the following further step:

At step 902, the device divides the DHC based price region into a region for load and a region for generation according to the following equations;

p=p_{nr_scr},Pₛᵢₜₑ∈[0,DHC_{uppb-P}_{_{ffl}}]

p=p_{nr_scr}−p_{nr_scr}^{max}[(Pₛᵢₜₑ−DHC_{uppb-P}_{_{ffl}})/(DHC_{max-P}_{_{ffl}}−DHC_{uppb-P}_{_{ffl}})]²,Pₛᵢₜₑ>DHC_{uppb-P}_{_{ffl}}

p=p_{nr_ld},Pₛᵢₜₑ∈[DHC_{lppb-P}_{_{ffl′}},0]

p=p_{nr_ld}+p_{nr_ld}^{max}[(Pₛᵢₜₑ−DHC_{uppb-P}_{_{ffl}})/(DHC_{min-P}_{_{ffl}}−DHC_{uppb-P}_{_{ffl}})]²,Pₛᵢₜₑ<DHC_{lppb-P}_{_{ffl}}

where p_{nr_scr} represents a normal compensation price for distributed energy resource (DER) injection power Pₛᵢₜₑ (positive) into a grid from the PCC of the electric charging site; p_{nr_ld} represents a normal billing price for electric charging site load power Pₛᵢₜₑ(negative) drawn from the grid at the PCC of the electric charging site; p_{nr_scr}^{max} and p_{nr_ld}^{max} represent maximum penalty prices the electric charging site needs to pay at its power injection or sink operation modes relative to the grid, respectively.

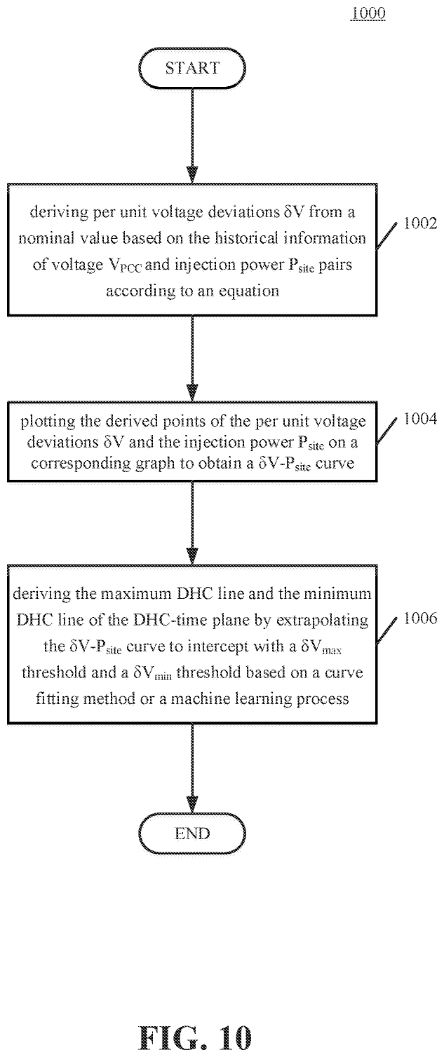

FIG. 10 is a schematic flowchart of a method 1000 for determining a charging price for an electric charging site using a device so to generate a charging price signal to present to an EV driver at the electric charging site. As shown in FIG. 10, the method 1000 for the device includes the following further steps:

At step 1002, the device derives per unit voltage deviations δV from a nominal value based on the historical information of voltage V_{PCC} and injection power Pₛᵢₜₑ pairs according to the following equation:

δV=V_{PCC}/V_{Base}−1

where V_{Base} is a rated voltage at the PCC of the electric charging site.

At step 1004, the device plots the derived points of the per unit voltage deviations δV and the injection power Pₛᵢₜₑ on a corresponding graph to obtain a δV-Pₛᵢₜₑ curve.

At step 1006, the device derives the maximum DHC line and the minimum DHC line of the DHC-time plane by extrapolating the δV-Pₛᵢₜₑ curve to intercept with a δVₘₐₓ threshold and a δVₘᵢₙ threshold based on a curve fitting method or a machine learning process.

The δVₘₐₓ threshold and the δVₘᵢₙ threshold are 0.05 and −0.05, respectively, according to local regulatory voltage limits.

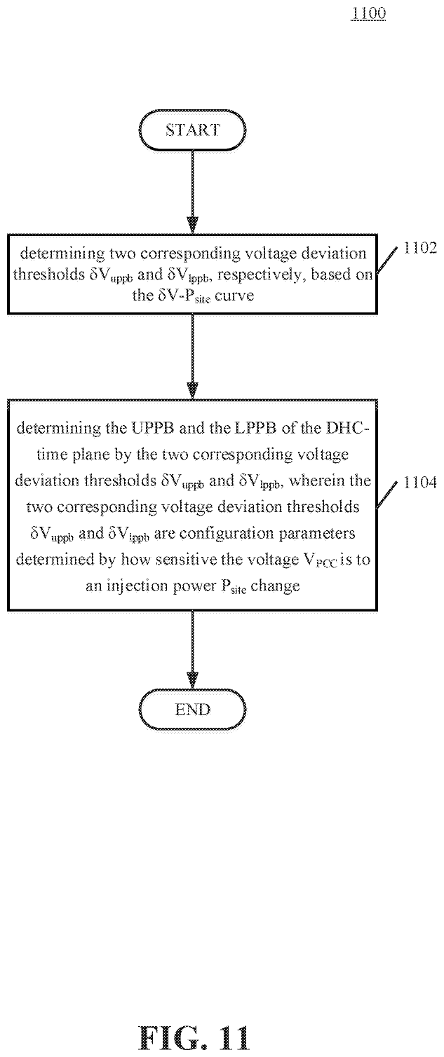

FIG. 11 is a schematic flowchart of a method 1100 for determining a charging price for an electric charging site using a device so to generate a charging price signal to present to an EV driver at the electric charging site. As shown in FIG. 11, the method 1100 for the device includes the following further steps:

At step 1102, the device determines two corresponding voltage deviation thresholds δV, lppb and δV_{lppb}, respectively, based on the δV-Pₛᵢₜₑ curve.

At step 1104, the device determines the UPPB and the LPPB of the DHC-time plane by the two corresponding voltage deviation thresholds δV, lppb and 0V_{lppb}. The two corresponding voltage deviation thresholds δV, lppb and δV_{lppb} are configuration parameters determined by how sensitive the voltage V_{PCC} is to an injection power Pₛᵢₜₑ change.

The two corresponding voltage derivation thresholds δV, lppb and δV_{lppb} are at least one of: chosen arbitrarily; according to voltage sensitivity study of the at least one electric charging site; or 0.04 and −0.04, respectively, when statutory limits for the δVₘₐₓ threshold and the δVₘᵢₙ threshold are 0.05 and −0.05, respectively.

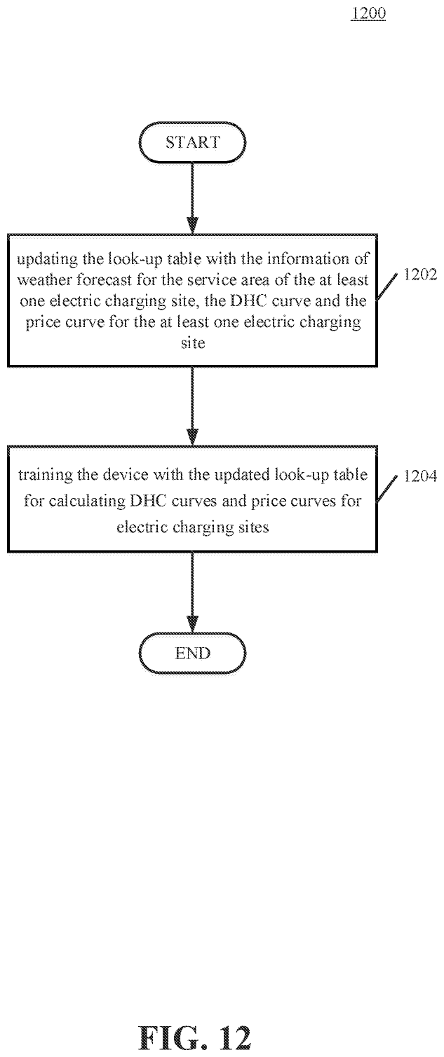

FIG. 12 is a schematic flowchart of a method 1200 for determining a charging price for an electric charging site using a device so to generate a charging price signal to present to an EV driver at the electric charging site. As shown in FIG. 12, the method 1200 for the device includes the following further steps:

At step 1202, the device updates the look-up table with the information of weather forecast for the service area of the at least one electric charging site, the DHC curve and the price curve for the at least one electric charging site.

At step 1204, the device trains itself with the updated look-up table for calculating DHC curves and price curves for electric charging sites.

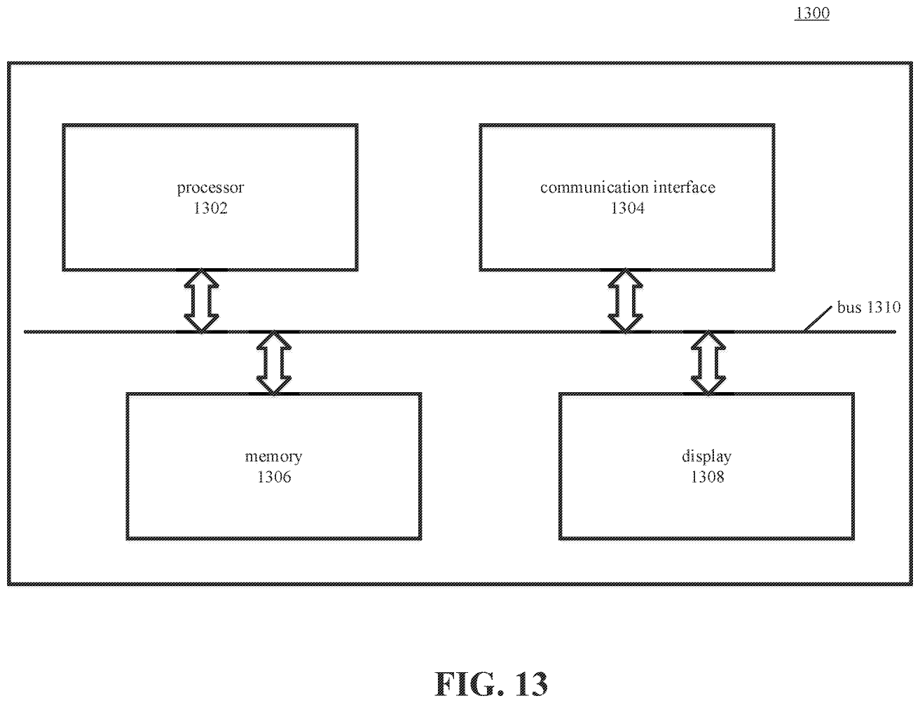

FIG. 13 is a schematic diagram of a device for determining a charging price for an electric charging site so to generate a charging price signal to present to an EV driver at the electric charging site. As shown in FIG. 13, the device 1300 for determining the charging price includes components, such as a bus 1310, a processor 1302, a communication interface 1304 and a memory 1306. Additionally and/or alternatively, the device may further include a display 1308. For example, the display 1308 may show various values received by the device, or various values entered by a user to the device. The display 1308 may also show various values that are output by the device, for example, to present a charging price signal to an EV driver at the electric charging site. Further, the processor 1302, the communication interface 1304, the memory 1306 and the display 1308 may communicate with each other through the bus 1310.

The processor 1302 may include one or more general-purpose processors, such as a central processing unit (CPU), or a combination of a CPU and a hardware chip. The hardware chip may be an application-specific integrated circuit (ASIC), a programmable logic device (PLD), or a combination thereof. The PLD may be a complex programmable logic device (CPLD), a field-programmable gate array (FPGA), generic array logic (GAL), or any combination thereof.

The memory 1306 may include a volatile memory, for example, a random access memory (RAM). The memory 1306 may further include a non-volatile memory (NVM), for example, a read-only memory (ROM), a flash memory, a hard disk drive (HDD), or a solid-state drive (SSD). The memory 1306 may further include a combination of the foregoing types.

The memory 1306 may have computer-readable program codes stored thereon. The processor 1302 may read the computer-readable program codes stored on the memory 1306 to implement the methods 700-1200 shown in FIGS. 7-12 described above to determine a charging price for an electric charging site so to generate a charging price signal to present to an EV driver at the electric charging site. Additionally and/or alternatively, the processor 1302 may read the computer-readable program codes stored on the memory 1306 to implement one or more other functions, a combination of these functions.

The processor 1302 may further communicate with another computing device through the communication interface 1304. For example, the processor 1302 may further communicate with an external physical memory or an external memory on a cloud to obtain necessary data for further data analysis, such as for calculating a center of mass and a distribution confidence parameter for clustered power consumption of at least one electric charging site to obtain a look-up table. Additionally and/or alternatively, the processor 1302 may further communicate with an automated metering infrastructure (AMI) to obtain relevant data for the at least one electric charging site. Additionally and/or alternatively, the processor 1302 may further communicate with a local or a remote server to obtain up-to-date information of weather forecast for a service area of the at least one electric charging site in real time.

The processor 1302 may further trigger the display 1308 to display information to a user. For example, the processor 1302 may trigger the display 1308 to display data that is related to the at least one electric charging site, time tags of the data, ambient temperature for a service area of the at least one electric charging site, historical information of voltage V_{PCC} and injection power Pₛᵢₜₑ pairs that is measured at a point of common coupling (PCC) of the electric charging site, and information of weather forecast for the service area of the at least one electric charging site.

For example, the processor 1302 may trigger the display 1308 to display results of analyzing the data, including the clustered power consumption of the at least one electric charging site, the calculated center of mass and distribution confidence parameter for the clustered power consumption, and the calculated dynamic hosting capacity (DHC) curve and price curve for the at least one electric charging site based on the center of mass and the distribution confidence parameter for the clustered power consumption, the historical information of voltage V_{PCC} and injection power Pₛᵢₜₑ pairs, and the information of weather forecast.

For example, the processor 1302 may trigger the display 1308 to display the look-up table that contains the results based on the analysis of the data. For example, the processor 1302 may trigger the display 1308 to display a real time status of the process of the determination of a charging price for an electric charging site so to generate a charging price signal to present to an EV driver at the electric charging site, as shown in FIGS. 7-12, and eventually the determined charging price to be presented as a charging price signal to an EV driver.

A person of ordinary skill in the art will appreciate that the device 1300 as shown in FIG. 13 may communicate with one or more further computing devices through the communication interface 1304 or wireless connections for further functions, or a combination of functions. The device 1300 as shown in FIG. 13 may also include one or more further functional components to perform and/or trigger further functions, or a combination of functions.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of the present disclosure are described herein, including the best mode known to the inventors for carrying out the disclosure. Variations of those exemplary embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method for determining a charging price for an electric charging site using a device, wherein the device comprises one or more processors configured to perform the method, comprising:
(1) receiving time tags and data for at least one electric charging site, which are obtained based on automated metering infrastructure (AMI) data for the at least one electric charging site, and temperature and/or weather related information for a service area of the at least one electric charging site;
(2) clustering power consumption of the at least one electric charging site with similar temperature and/or weather related information and time tags;
(3) calculating a center of mass and a distribution confidence parameter for the clustered power consumption of the at least one electric charging site to obtain a look-up table;
(4) retrieving historical information of voltage V_{PCC} and injection power Pₛᵢₜₑ pairs that is measured at a point of common coupling (PCC) of the at least one electric charging site and stored on a memory of the device;
(5) receiving weather forecast information for the service area of the at least one electric charging site; and
(6) calculating a dynamic hosting capacity (DHC) curve and a price curve for the at least one electric charging site based on the center of mass and the distribution confidence parameter for the clustered power consumption, the historical information of voltage V_{PCC} and injection power Pₛᵢₜₑ pairs, and the weather forecast information.

2. The method of claim 1, the method further comprising:
identifying a maximum DHC line and a minimum DHC line of the DHC-time plane;
identifying an upper premium price boundary (UPPB) and a lower premium price boundary (LPPB) of the DHC-time plane; and
dividing a region between the maximum DHC line and the minimum DHC line of the DHC-time plane into three sub-regions,
wherein the three sub-regions comprise a first premium price region that is between the maximum DHC line and the UPPB of the DHC-time plane, a second premium price region that is between the LPPB and the minimum DHC line of the DHC-time plane, and a DHC based price region that is between the UPPB and LPPB of the DHC-time plane.

3. The method of claim 2, further comprising:
dividing the DHC based price region into a region for load and a region for generation according to the following equations:
P=P_{nr_scr},Pₛᵢₜₑ∈[0,DHC_{uppb-P}_{_{ffl}}]
p=p_{nr_scr}−p_{nr_scr}^{max}[(Pₛᵢₜₑ−DHC_{uppb-P}_{_{ffl}})/(DHC_{max-P}_{_{ffl}}−DHC_{uppb-P}_{_{ffl}})]²,Pₛᵢₜₑ>DHC_{uppb-P}_{_{ffl}}
p=p_{nr_ld},Pₛᵢₜₑ∈[DHC_{lppb-P}_{_{ffl}},0]
p=p_{nr_ld}+p_{nr_ld}^{max}[(Pₛᵢₜₑ−DHC_{uppb-P}_{_{ffl}})/(DHC_{min-P}_{_{ffl}}−DHC_{uppb-P}_{_{ffl}})]²,Pₛᵢₜₑ<DHC_{lppb-P}_{_{ffl}}
wherein p_{nr_scr} represents a normal compensation price for distributed energy resource (DER) injection power Pₛᵢₜₑ (positive) into a grid from the PCC of the electric charging site; p_{nr_ld} represents a normal billing price for electric charging site load power Pₛᵢₜₑ (negative) drawn from the grid at the PCC of the electric charging site; p_{nr_scr}^{max}, and p_{nr_ld}^{max} represent maximum penalty prices the electric charging site needs to pay at its power injection or sink operation modes relative to the grid, respectively.

4. The method of claim 2, wherein identifying the maximum DHC line and the minimum DHC line of the DHC-time plane comprises:
deriving per unit voltage deviations δV from a nominal value based on the historical information of voltage V_{PCC} and injection power Pₛᵢₜₑ pairs according to the following equation:
δV=V_{PCC}/V_{Base}−1
wherein V_{Base} is a rated voltage at the PCC of the electric charging site,
plotting the derived points of the per unit voltage deviations δV and the injection power Pₛᵢₜₑ on a corresponding graph to obtain a δV-Pₛᵢₜₑ curve; and
deriving the maximum DHC line and the minimum DHC line of the DHC-time plane by extrapolating the δV-Pₛᵢₜₑ curve to intercept with a δVₘₐₓ threshold and a δVₘᵢₙ threshold based on a curve fitting method or a machine learning process.

5. The method of claim 4, wherein the δVₘₐₓ threshold and the δVₘᵢₙ threshold are 0.05 and −0.05, respectively, according to local regulatory voltage limits.

6. The method of claim 4, wherein identifying the UPPB and the LPPB of the DHC-time plane comprises:
determining two corresponding voltage deviation thresholds δV_{uppb} and δV_{lppb}, respectively, based on the δV-Pₛᵢₜₑ curve; and
determining the UPPB and the LPPB of the DHC-time plane by the two corresponding voltage deviation thresholds δV_{uppb} and δV_{lppb},
wherein the two corresponding voltage deviation thresholds δV_{uppb} and δV_{lppb} are configuration parameters determined by how sensitive the voltage V_{PCC} is to an injection power Pₛᵢₜₑ change.

7. The method of claim 6, wherein the two corresponding voltage derivation thresholds δV_{uppb} and δV_{lppb} are at least one of:
chosen arbitrarily;
according to voltage sensitivity study of the at least one electric charging site; or
0.04 and −0.04, respectively, when statutory limits for the δVₘₐₓ threshold and the δVₘᵢₙ threshold are 0.05 and −0.05, respectively.

8. The method of claim 1, further comprising:
updating the look-up table with the information of weather forecast for the service area of the at least one electric charging site, the DHC curve and the price curve for the at least one electric charging site.

9. The method of claim 8, further comprising:
training the device with the updated look-up table for calculating DHC curves and price curves for electric charging sites.

10. The method claim 1, wherein the device conducts the method steps (1)-(3) off-line, and the method steps (4)-(6) on-line.

11. A device for determining a charging price for an electric charging site, the device comprising one or more processors configured to:
receive time tags and data for at least one electric charging site, which are obtained based on automated metering infrastructure (AMI) data for the at least one electric charging site, and temperature and/or weather related information for a service area of the at least one electric charging site;
cluster power consumption of the at least one electric charging site with similar temperature and/or weather related information and time tags;
calculate a center of mass and a distribution confidence parameter for the clustered power consumption of the at least one electric charging site to obtain a look-up table;
retrieve historical information of voltage V_{PCC} and injection power Pₛᵢₜₑ pairs that is measured at a point of common coupling (PCC) of the at least one electric charging site and stored on a memory of the device;
receive weather forecast information for the service area of the at least one electric charging site; and
calculate a dynamic hosting capacity (DHC) curve and a price curve for the at least one electric charging site based on the center of mass and the distribution confidence parameter for the clustered power consumption, the historical information of voltage V_{PCC} and injection power Pₛᵢₜₑ pairs, and the weather forecast information.

12. The device of claim 11, the one or more processors further configured to:
identify a maximum DHC line and a minimum DHC line of the DHC-time plane;
identify an upper premium price boundary (UPPB) and a lower premium price boundary (LPPB) of the DHC-time plane; and
divide a region between the maximum DHC line and the minimum DHC line of the DHC-time plane into three sub-regions,
wherein the three sub-regions comprise a first premium price region that is between the maximum DHC line and the UPPB of the DHC-time plane, a second premium price region that is between the LPPB and the minimum DHC line of the DHC-time plane, and a DHC based price region that is between the UPPB and LPPB of the DHC-time plane.

13. The device of claim 12, the one or more processors further configured to:
divide the DHC based price region into a region for load and a region for generation according to the following equations:
P=p_{nr_scr},Pₛᵢₜₑε[0,DHC_{uppb-P}_{_{ffl}}]
p=p_{nr_scr}−p_{nr_scr}^{max}[(Pₛᵢₜₑ−DHC_{uppb-P}_{_{ffl}})/(DHC_{max-P}_{_{ffl}}−DHC_{uppb-P}_{_{ffl}})]²,Pₛᵢₜₑ>DHC_{uppb-P}_{_{ffl}}
p=p_{nr_ld},Pₛᵢₜₑε[DHC_{lppb-P}_{_{ffl}},0]
p=p_{nr_ld}+p_{nr_ld}^{max}[(Pₛᵢₜₑ−DHC_{uppb-P}_{_{ffl}})/(DHC_{min-P}_{_{ffl}}−DHC_{uppb-P}_{_{ffl}})]²,Pₛᵢₜₑ<DHC_{lppb-P}_{_{ffl}}
wherein p_{nr_scr} represents a normal compensation price for distributed energy resource (DER) injection power Pₛᵢₜₑ (positive) into a grid from the PCC of the electric charging site; p_{nr_ld} represents a normal billing price for electric charging site load power Pₛᵢₜₑ (negative) drawn from the grid at the PCC of the electric charging site; p_{nr_scr}^{max} and p_{nr_ld}^{max} represent maximum penalty prices the electric charging site needs to pay at its power injection or sink operation modes relative to the grid, respectively.

14. The device of claim 12, wherein identifying the maximum DHC line and the minimum DHC line of the DHC-time plane comprises:
deriving per unit voltage deviations δV from a nominal value based on the historical information of voltage V_{PCC} and injection power Pₛᵢₜₑ pairs according to the following equation:
δV=V_{PCC}/V_{Base}−1
wherein V_{Base} is a rated voltage at the PCC of the electric charging site,
plotting the derived points of the per unit voltage deviations δV and the injection power Pₛᵢₜₑ on a corresponding graph to obtain a δV-Pₛᵢₜₑ curve; and
deriving the maximum DHC line and the minimum DHC line of the DHC-time plane by extrapolating the δV-Pₛᵢₜₑ curve to intercept with a δVₘₐₓ threshold and a δVₘᵢₙ threshold based on a curve fitting method or a machine learning process.

15. The device of claim 14, wherein the δVₘₐₓ threshold and the δVₘᵢₙ threshold are 0.05 and −0.05, respectively, according to local regulatory voltage limits.

16. The device of claim 14, wherein identifying the UPPB and the LPPB of the DHC-time plane comprises:
determining two corresponding voltage deviation thresholds δV_{uppb} and δV_{lppb}, respectively, based on the δV-Pₛᵢₜₑ curve; and
determining the UPPB and the LPPB of the DHC-time plane by the two corresponding voltage deviation thresholds δV_{uppb} and δV_{lppb},
wherein the two corresponding voltage deviation thresholds δV_{uppb} and δV_{lppb} are configuration parameters determined by how sensitive the voltage V_{PCC} is to an injection power Pₛᵢₜₑ change.

17. The device of claim 16, wherein the two corresponding voltage derivation thresholds δV_{uppb} and δV_{lppb} are at least one of:
chosen arbitrarily;
according to voltage sensitivity study of the at least one charging site; or
0.04 and −0.04, respectively, when statutory limits for the δVₘₐₓ threshold and the δVₘᵢₙ threshold are 0.05 and −0.05, respectively.

18. The device of claim 11, the one or more processors further configured to:
update the look-up table with the information of weather forecast for the service area of the at least one electric charging site, the DHC curve and the price curve for the at least one electric charging site.

19. The device of claim 18, the one or more processors further configured to:
train the device with the updated look-up table for calculating DHC curves and price curves for electric charging sites.

20. A non-transitory computer-readable medium having computer-executable instructions stored thereon which, when executed by one or more processors, cause a device to:
receive time tags and data for at least one electric charging site, which are obtained based on automated metering infrastructure (AMI) data for the at least one electric charging site, and temperature and/or weather related information for a service area of the at least one electric charging site;
cluster power consumption of the at least one electric charging site with similar temperature and/or weather related information and time tags;
calculate a center of mass and a distribution confidence parameter for the clustered power consumption of the at least one electric charging site to obtain a look-up table;
retrieve historical information of voltage V_{PCC} and injection power Pₛᵢₜₑ pairs that is measured at a point of common coupling (PCC) of the at least one electric charging site and stored on a memory of the device;
receive weather forecast information for the service area of the at least one electric charging site; and
calculate a dynamic hosting capacity (DHC) curve and a price curve for the at least one electric charging site based on the center of mass and the distribution confidence parameter for the clustered power consumption, the historical information of voltage V_{PCC} and injection power Pₛᵢₜₑ pairs, and the weather forecast information.
